(19) United States
(12) Patent Application Publication
(10) Pub. No.: US 2016/0160614 A1
(43) Pub. Date: Jun. 9, 2016

(54) SUBSEA CONTAINMENT SEPARATOR

(71) Applicant: SHELL OIL COMPANY, Houston, TX (US)

(72) Inventors: John Michael WARD, Fulshear, TX (US); Moye WICKS, Houston, TX (US); Karl Gregory ANDERSON, Missouri City, TX (US); Juan Pablo PONTAZA, Katy, TX (US)

(21) Appl. No.: 14/907,035

(22) PCT Filed: Jul. 22, 2014
(86) PCT No.: PCT/US2014/047507

§ 371 Date: Jan. 22, 2016

Related U.S. Application Data
(60) Provisional application No. 61/857,915, filed on Jul. 24, 2013.

(51) Int. Cl. E21B 43/01; C02F 1/40

(52) U.S. Cl. CPC E21B 43/0122; C02F 1/40; C02F 2101/32

(57) ABSTRACT

An open water capture device comprising: a subsea collector and a subsea containment separator connected to the subsea collector, wherein the subsea containment separator comprises a top surface, a bottom surface, an outer surface, a riser comprising a diffuser section, wherein the riser penetrates the bottom surface of the subsea containment separator, and a baffle, wherein the baffle defines a first concentric annular region and a second concentric annular region.

### CROSS REFERENCE TO RELATED APPLICATIONS

This application claims the benefit of U.S. Provisional Application No. 61/857,915, filed Jul. 24, 2013, which is incorporated herein by reference.

### BACKGROUND

The present disclosure relates generally to open water capture devices. More specifically, in certain embodiments the present disclosure relates to open water capture devices comprising subsea containment separators and associated systems.

When oil and gas are spilled into the sea, for example from a leaking pipelines, seepage from underground formations, or from oil flowing from a subsea wellhead or blowout preventer, there is a desire to collect the oil and gas and contain and transport or otherwise dispose of the oil and gas to prevent environmental damage to the sea and nearby coastlines. Conventional methods and devices are described in U.S. Patent Application Publication Nos. 2012/0051841, 2012/0051840, and 2012/0213587, the entireties of which are hereby incorporated by reference.

Conventional methods typically involve placing an open water capture device over the leak. Such designs may include simple inverted funnels that capture a rising gas plume along with entrained oil and water. These simple funnels may work well on small rate leaks with low gas flows; however, their size may become impractical for large leaks with significant gas plumes. These simple funnels may have only a single outlet line for gas with entrained liquids.

A rising gas plume entrains so much sea water (often more than twenty times the volume of oil being entrained) that surface separation equipment may not be able to handle the flow. The amount of water entering with the hydrocarbon fluid has been a persistent problem in past attempts to collect oil and gas leaking into water.

It is desirable to provide a subsea capture device that is capable of separating water from oil and gas.

### SUMMARY

The present disclosure relates generally to open water capture devices. More specifically, in certain embodiments the present disclosure relates to open water capture devices comprising subsea containment separators and associated systems.

In one embodiment, the present disclosure provides an open water capture device comprising: a subsea collector and a subsea containment separator connected to the subsea collector, wherein the subsea containment separator comprises a top surface, a bottom surface, an outer surface, a riser comprising a diffuser section, wherein the riser penetrates the bottom surface of the subsea containment separator, and a baffle, wherein the baffle defines a first concentric annular region and a second concentric annular region.

In another embodiment, the present disclosure provides an open water containment system comprising: an open water capture device, wherein the open water capture device comprises: a subsea collector and a subsea containment separator connected to the subsea collector, wherein the subsea containment separator comprises a top surface, a bottom surface, and an outer surface, a riser comprising a diffuser section, wherein the riser penetrates the bottom surface of the subsea containment separator, and a baffle, wherein the baffle defines a first concentric annular region and a second concentric annular region and a leak source, wherein the open water capture device is placed above the leak source.

In another embodiment, the present disclosure provides a method for capturing a oil and gas from a leak source comprising: providing an open water capture device, wherein the wherein the open water capture device comprises: a subsea collector and a subsea containment separator connected to the subsea collector, wherein the subsea containment separator comprises a top surface, a bottom surface, and an outer surface, a riser comprising a diffuser section, wherein the riser penetrates the bottom surface of the subsea containment separator, and a baffle, wherein the baffle defines a first concentric annular region and a second concentric annular region; placing the open water capture device above a plume from a leak source; and allowing oil and gas from the leak source to flow into the open water capture device.

### BRIEF DESCRIPTION OF THE DRAWINGS

So that the above recited features and advantages of the disclosure may be understood in detail, a more particular description of the disclosure, briefly summarized above, may be had by reference to the embodiments thereof that are illustrated in the appended drawings. It is to be noted, however, that the appended drawings illustrate only typical embodiments of this disclosure and are, therefore, not to be considered limiting of its scope. The figures are not necessarily to scale, and certain features and certain views of the figures may be shown exaggerated in scale or in schematic in the interest of clarity and conciseness.

FIG. 1 is an illustration of an open water capture device in accordance with an embodiment of the present disclosure.

FIG. 2 is an illustration of a subsea containment separator in accordance with an embodiment of the present disclosure.

FIG. 3 is an illustration of a subsea containment system in accordance with an embodiment of the present disclosure.

FIG. 4 is a process flow diagram in accordance with certain embodiments of the present disclosure.

The features and advantages of the present disclosure will be readily apparent to those skilled in the art. While numerous changes may be made by those skilled in the art, such changes are within the spirit of the disclosure.

### DETAILED DESCRIPTION

The description that follows includes exemplary apparatuses, methods, techniques, and/or instruction sequences that embody techniques of the inventive subject matter. However, it is understood that the described embodiments may be practiced without these specific details.

The present disclosure relates generally to open water capture devices. More specifically, in certain embodiments the present disclosure relates to open water capture devices comprising subsea containment separators and associated systems.

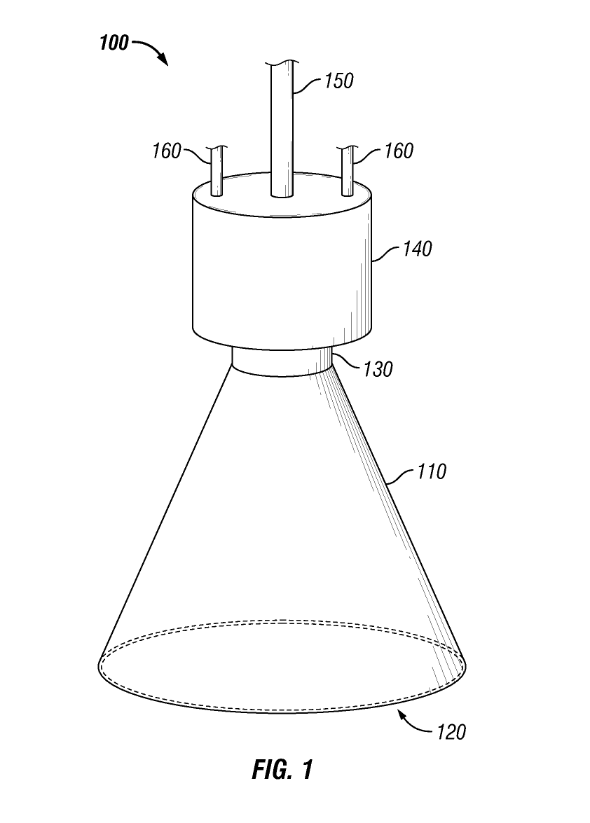

Referring now to FIG. 1, FIG. 1 illustrates an open water capture device 100 in accordance with certain embodiments of the present disclosure. In certain embodiments, open water capture device 100 may comprise a subsea collector 110 with an open bottom 120, a top portion 130, and a subsea containment separator 140.

In certain embodiments, subsea collector 110 may have a dome, a funnel, or a tent shape. Subsea collector 110 may be constructed out of any material suitable for in a deepwater environment. Examples of suitable materials include steel.

In certain embodiments, subsea collector 110 may have an open bottom 120. Open bottom 120 of subsea collector 110 may be open to the water. In certain embodiments, open bottom 120 may be large enough to capture, and/or enclose the fluids escaping from one or more subsea leak sources.

In certain embodiments, subsea collector 110 may have a top portion 130. Top portion 130 may be connected to a subsea containment separator 140. In certain embodiments top portion 130 may extend into subsea containment separator 140. In certain embodiments, top portion 130 may comprise a riser.

In certain embodiments, open water capture device 100 may further comprise one or more gas flow lines 150 and one or more oil flow lines 160. Gas flow line 150 and oil flow line 160 may extend from subsea containment separator 140 to a surface facility or a floating vessel.

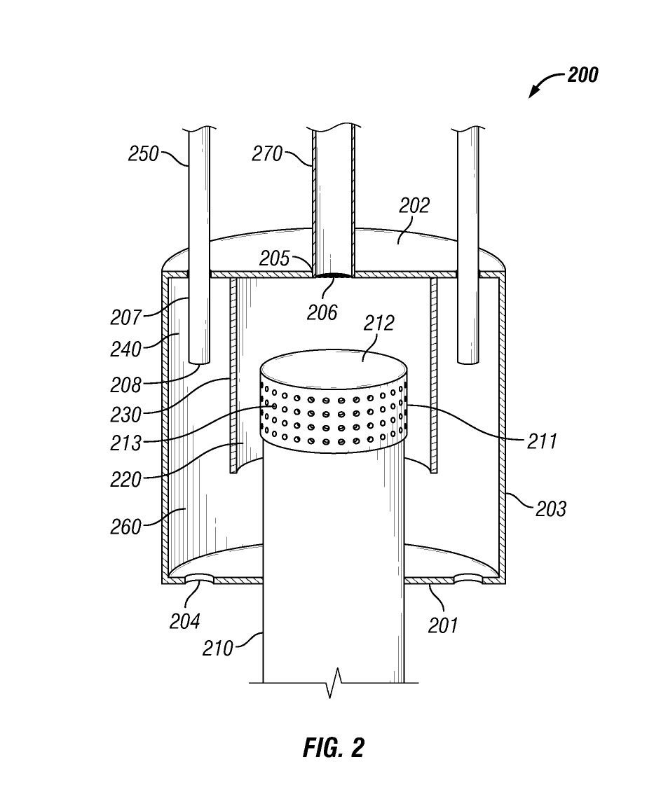

Referring now to FIG. 2, FIG. 2 illustrates a subsea containment separator 200 in accordance with certain embodiments of the present disclosure. Subsea containment separator 200 may be cylindrically shaped. Subsea containment separator 200 may be partially or completely hollow. In certain embodiments, subsea containment separator 200 may comprise a bottom surface 201, a top surface 202, and an outer surface 203. Subsea containment separator 200 may be constructed out of any material suitable for in a deepwater environment. Examples of suitable materials include steel.

In certain embodiments, subsea containment separator may comprise a riser 210 extending into subsea containment separator 200 through bottom surface 201. In certain embodiments, riser 210 may comprise a top portion of a subsea collector. In other embodiments, riser 210 may be connected a top portion of a subsea collector.

Riser 210 may be constructed out of any material suitable for use in a subsea environment. In certain embodiments, riser 210 may be cylindrically shaped. In certain embodiments, riser 210 may comprise a diffuser section 211 and a capped end 212. In certain embodiments, diffuser section 211 may comprise a plurality of radial holes 213. In certain embodiments, riser 210 may extend into a first concentric annular region 220 of the subsea containment separator. In certain embodiments, diffuser section 211 may be located within this first concentric annular region.

In certain embodiments, first concentric annular region 220 may be defined by a baffle 230. Baffle 230 may be cylindrical in shape. In certain embodiments, baffle 230 may extend from the top surface 202 of subsea containment separator 200. Baffle 230 may further define a second concentric annular region 240 between baffle 230 and the outer surface 203 of the subsea containment separator 200. In certain embodiments, subsea containment separator may comprise a third annular region 260 defined by riser 210 and outer surface 203.

In certain embodiments, subsea collector 200 may comprise one or more holes 204 on bottom surface 201. The one or more holes 204 may permit water to flow out of subsea collector 200.

In certain embodiments, subsea collector 200 may comprise an opening 205 on the top surface 202. In certain embodiments, opening 205 may be at least partially covered by wire mesh 206. In certain embodiments, a gas flow line 270 may be attached to opening 205.

In certain embodiments, subsea collector 200 may comprise an oil outlet tube 207 with an opening 208 extending from the second annular concentric region 240 through the top surface 202. In certain embodiments, an oil flow line 250 may be attached to the top of the oil outlet tube 207. In certain embodiments, subsea collector may further comprise a pump (not illustrated) that pumps the oil from the subsea collector 200 through the oil flow line 250.

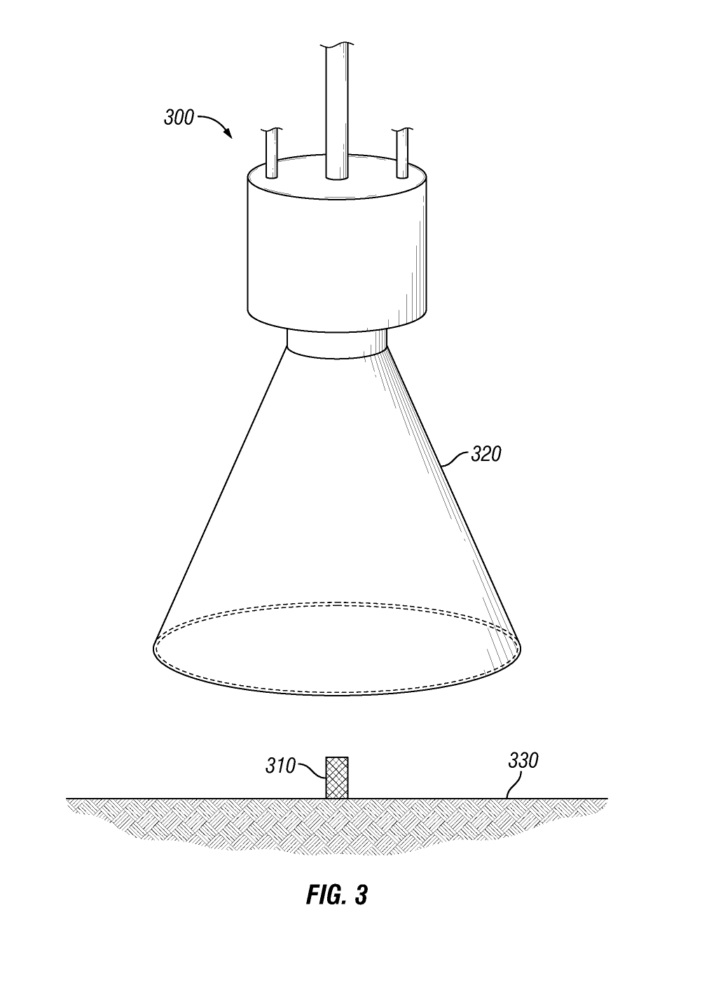

Referring now to FIG. 3, FIG. 3 illustrates subsea containment system 300. In certain embodiments, subsea containment system 300 may comprise a subsea leak 310 and open water capture device 320.

Open water capture device 320 may comprise any combination of features discussed above with respect to open water capture device 100. In certain embodiments, the subsea containment separator 140 of FIG. 1 may include any of the features discussed above with respect to the subsea containment separator 200 of FIG. 2.

In certain embodiments, subsea leak 310 may comprise a leak from sea floor 330 or a leak from a piece of subsea equipment. In certain embodiments, oil and gas from the leak source 310, as well as water, may flow into the open water capture device 320 from leak source 310 where the oil, water, and gas may be separated.

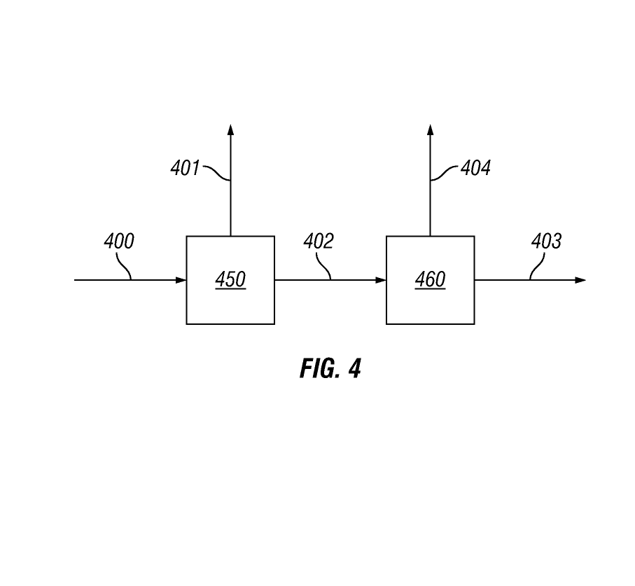

Referring now to FIG. 4, FIG. 4 illustrates a process flow diagram in accordance with certain embodiments of the present disclosure. A mixture of oil, gas, and water stream 400 may flow into the first annular concentric region 450 of a subsea containment separator. In certain embodiments, a short riser pipe may create a low pressure zone drawing the oil and gas and water into the first annular concentric region 450. In the first annular concentric region 450, gas may separate from the oil and water forming a gas stream 401 and an oil/water stream 402. The oil/water stream 402 may then flow under the baffle and into the second annular concentric region 460. Oil may separate from water in the second annular concentric region forming a water stream 403 and an oil stream 404. The water stream 403 may exit the subsea containment separator via holes in the bottom of the separator. The oil may be pumped to the surface.

In one embodiment, the present disclosure provides a subsea containment separator that uses gas lift created by a gas plume to entrain the oil along with a significant quantity of sea water and carry it into a simple gravity separator. Once in the separator, a combination of changes in flow direction and reduced flow velocities allow the phases to separate. Gas with minimal liquid entrained flow out one line while oil with some water is pumped out another line. The pumping action also induces a flow through the oil/water separating section of the device. Water with little or no oil entrained flows by gravity out the bottom of the device.

In certain embodiments, the open water capture device described herein may be designed to intercept a subsea oil and gas plume resulting from a well control incident or pipeline leak, separate the entrained oil and water from the gas plume, and send the oil and gas to the surface in separate lines for processing while leaving the water in the sea. In certain embodiments, the open water capture device may solve the problem of previous subsea containment dome designs in which a large volumes of sea water was entrained in the intercepted plume and brought to the surface by separating the water subsea and leaving it in the sea.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. An open water capture device comprising:
a subsea collector and
a subsea containment separator connected to the subsea collector, wherein the subsea containment separator comprises a top surface, a bottom surface, an outer surface, a riser comprising a diffuser section, wherein the riser penetrates the bottom surface of the subsea containment separator, and a baffle, wherein the baffle defines a first concentric annular region and a second concentric annular region.

2. The open water capture device of claim 1, wherein the subsea collector has a dome, funnel, or tent shape.

3. The open water capture device of claim 1, wherein the diffuser section comprises a plurality of radial holes.

4. The open water capture device of claim 1, wherein the diffuser section comprises a capped end.

5. The open water capture device of claim 1, wherein the subsea containment separator comprises a gas flow line attached to an opening on the top surface.

6. The open water capture device of claim 5, wherein the opening on the top surface is covered with wire mesh.

7. The open water capture device of claim 1, wherein the subsea containment separator comprises one or more oil flow lines attached to an opening on the top surface.

8. The open water capture device of claim 1, wherein the subsea containment separator comprises one or more holes penetrating the bottom surface.

9. An open water containment system comprising:
an open water capture device, wherein the open water capture device comprises:
a subsea collector and
a subsea containment separator connected to the subsea collector, wherein the subsea containment separator comprises a top surface, a bottom surface, and an outer surface, a riser comprising a diffuser section, wherein the riser penetrates the bottom surface of the subsea containment separator, and a baffle, wherein the baffle defines a first concentric annular region and a second concentric annular region and
a leak source, wherein the open water capture device is placed above the leak source.

10. The open water containment system of claim 9, wherein the subsea collector has a dome, funnel, or tent shape.

11. The open water containment system of claim 9, wherein the diffuser section comprises a plurality of radial holes.

12. The open water containment system of claim 9, wherein the diffuser section comprises a capped end.

13. The open water containment system of claim 9, wherein the subsea containment separator comprises a gas flow line attached to an opening on the top surface.

14. The open water containment system of claim 13, wherein the opening on the top surface is covered with wire mesh.

15. The open water containment system of claim 9, wherein the subsea containment separator comprises one or more oil flow lines attached to an opening on the top surface.

16. The open water containment system of claim 9, wherein the subsea containment separator comprises one or more holes penetrating the bottom surface.

17. A method for capturing a oil and gas from a leak source comprising:
providing an open water capture device, wherein the wherein the open water capture device comprises:
a subsea collector and
a subsea containment separator connected to the subsea collector, wherein the subsea containment separator comprises a top surface, a bottom surface, an outer surface, a riser comprising a diffuser section, wherein the riser penetrates the bottom surface of the subsea containment separator, and a baffle, wherein the baffle defines a first concentric annular region and a second concentric annular region;
placing the open water capture device above a plume from a leak source; and
allowing oil and gas from the leak source to flow into the open water capture device.

18. The method of claim 17, wherein oil is allowed to flow from the subsea containment separator through an oil outlet tube.

19. The method of claim 17, wherein gas is allowed to flow from the subsea containment separator through a gas outlet tube.

20. The method of claim 17, wherein water is allowed to flow from the subsea containment separator through one or more holes penetrating the bottom surface.
